(19) United States
(12) Patent Application Publication
(10) Pub. No.: US 2026/0346690 A1
(43) Pub. Date: Nov. 5, 2026

(54) MODULAR WINDOW SYSTEM FOR A VEHICLE

(71) Applicant: Rivian IP Holdings, LLC, Irvine, CA (US)

(72) Inventors: Travis James Lonas, Foothill Ranch, CA (US); Phillip Paul Whitton, Irvine, CA (US)

(21) Appl. No.: 19/198,870

(22) Filed: May 5, 2025

(51) Int. Cl. B60J 10/21; B60J 10/22; B60J 10/23; B60J 10/75; B60J 10/76

(52) U.S. Cl. CPC B60J 10/21; B60J 10/22; B60J 10/23; B60J 10/75; B60J 10/76

(57) ABSTRACT

An apparatus includes a carrier structure that is coupled to a vehicle structure of a vehicle and a window seal structure for a window. The carrier structure includes a top, a bottom, and two sides. The window includes an inner surface that faces an inside of the vehicle and an outer surface that faces an outside of the vehicle. The top and two sides of the carrier structure couple to a first surface of the vehicle structure. The bottom of the carrier structure couples to a second surface of the vehicle structure. When the carrier structure is coupled to the vehicle structure, the first surface is inward of the inner surface of the window and the second surface is outward of the outer surface of the window. The first surface and the second surface of the vehicle structure form an opening for the window.

### INTRODUCTION

The present disclosure is directed to a system and method for a modular window, and more particularly to a system and method for incorporating common and modular elements into a vehicle to accommodate different types of windows.

### SUMMARY

A vehicle may have several windows. The windows may be of a window type, such as a fixed window or a movable window, which is fixed or movable in relation to a structure of the vehicle. For example, a front window may be a fixed window and a front driver's side window may be a movable window. Vehicle models may have different variants, and each variant may have different features. A base variant of a sport utility vehicle (SUV) may include a base liftgate with a base liftgate structure coupled to a fixed rear window. An upgraded variant of the SUV may include an upgraded liftgate with an upgraded liftgate structure coupled to a movable rear window. The base liftgate structure may differ from the upgraded liftgate structure in order to accommodate the differences in the fixed and movable rear window designs. The different liftgate structures may increase production cost and/or increase supply chain complexity. Accordingly, there is a need for a system that may incorporate either one of a fixed window or a movable window into a common vehicle structure.

In some embodiments, a window assembly comprises a carrier structure. The carrier structure comprises a top, a bottom, and two sides. The carrier structure is configured to be coupled to (i) a vehicle structure of a vehicle and (ii) a window seal structure for a window. The window comprises an inner surface configured to face an inside of the vehicle and an outer surface configured to face an outside of the vehicle. The top and two sides of the carrier structure are configured to be coupled to a first surface of the vehicle structure. The bottom of the carrier structure is configured to be coupled to a second surface of the vehicle structure. When the carrier structure is coupled to the vehicle structure, the first surface of the vehicle structure is inward of the inner surface of the window and the second surface of the vehicle structure is outward of the outer surface of the window. The first surface and the second surface of the vehicle structure form an opening for the window.

In some embodiments, the carrier structure further comprises two transition sections that respectively couple the two sides to the bottom. In some embodiments, the two transition sections of the carrier structure are configured to be coupled to respective transition surfaces of the vehicle structure. When the carrier structure is coupled to the vehicle structure, the transition surfaces of the vehicle structure transition from inward of the inner surface of the window to outward of the outer surface of the window.

In some embodiments, a vehicle structure of a vehicle comprises a first surface and a second surface that are configured to be coupled to either one of a first type of carrier structure or a second type of carrier. The first type of carrier structure is for securing a fixed window to the vehicle structure. The fixed window comprises an inner surface and an outer surface. When the first type of carrier structure is coupled to the vehicle structure, the inner surface of the fixed window is configured to face an inside of the vehicle and the outer surface of the fixed window is configured to face an outside of the vehicle. The first surface of the vehicle structure is inward of the inner surface of the fixed window. The second surface of the vehicle structure is outward of the outer surface of the fixed window. Further, when the first type of carrier structure is coupled to the vehicle structure, the fixed window is configured to be fixed in relation to the vehicle structure.

The second type of carrier structure is for securing a movable window to the vehicle structure. The movable window comprises an inner surface and an outer surface. When the second type of carrier structure is coupled to the vehicle structure the inner surface of the movable window is configured to face an inside of the vehicle and the outer surface of the movable window is configured to face an outside of the vehicle. The first surface of the vehicle structure is inward of the inner surface of the movable window. The second surface of the vehicle structure is outward of the outer surface of the movable window. Further, when the second type of carrier structure is coupled to the vehicle structure, the movable window is configured to be moved in relation to the vehicle structure.

In some embodiments, the first type of carrier structure and the second type of carrier structure are configured to position the respective fixed window and movable window at a substantially similar first standoff distance from the first surface. In some embodiments, the first type of carrier structure and the second type of carrier structure are configured to position the respective fixed window and movable window at a substantially similar second standoff distance from the second surface.

In some embodiments, a vehicle comprises a vehicle structure, a window, and a carrier structure. The vehicle structure comprises a continuous surface that includes a first surface and a second surface. The window comprises an inner surface and an outer surface. The carrier structure is coupled to the window and the vehicle structure. The carrier structure comprises a top and a bottom. The inner surface of the window faces an inside of the vehicle and the outer surface of the window faces an outside of the vehicle. The first surface of the vehicle structure is inward of the inner surface of the window and the top of the carrier structure is coupled to the first surface of the vehicle structure. The second surface of the vehicle structure is outward of the outer surface of the window and the bottom of the carrier structure is coupled to the second surface of the vehicle structure.

### BRIEF DESCRIPTION OF THE DRAWINGS

The present disclosure, in accordance with one or more various embodiments, is described in detail with reference to the following figures. The drawings are provided for purposes of illustration only and merely depict typical or example embodiments. These drawings are provided to facilitate an understanding of the concepts disclosed herein and should not be considered limiting of the breadth, scope, or applicability of these concepts. It should be noted that for clarity and ease of illustration, these drawings are not necessarily made to scale.

FIG. 1 is a schematic illustration of a vehicle window system, in accordance with embodiments of the disclosure;

FIG. 2A is a schematic illustration of a vehicle structure for coupling to different types of windows, in accordance with embodiments of the disclosure;

FIG. 2B is a schematic sectional illustration of the vehicle structure from FIG. 2A and a window, in accordance with embodiments of the disclosure;

FIG. 3 is a schematic illustration of a carrier structure for coupling a fixed window to a vehicle structure, in accordance with embodiments of the disclosure;

FIG. 4A is a schematic sectional view of a top of the carrier structure from FIG. 3, in accordance with embodiments of the disclosure;

FIG. 4B is a schematic sectional view of a side of the carrier structure from FIG. 3, in accordance with embodiments of the disclosure;

FIG. 4C is a schematic sectional view of a bottom of the carrier structure from FIG. 3, in accordance with embodiments of the disclosure;

FIG. 5 is a schematic illustration of a carrier structure for coupling a movable window to a vehicle structure, in accordance with embodiments of the disclosure;

FIG. 6A is a schematic sectional view of a top of the carrier structure from FIG. 5, in accordance with embodiments of the disclosure;

FIG. 6B is a schematic sectional view of a side of the carrier structure from FIG. 5, in accordance with embodiments of the disclosure;

FIG. 6C is a schematic sectional view of a bottom of the carrier structure from FIG. 5, in accordance with embodiments of the disclosure;

FIG. 7A is a schematic sectional view of a top of a carrier structure for a fixed window, in accordance with embodiments of the disclosure;

FIG. 7B is a schematic sectional view of a bottom of a carrier structure for a fixed window, in accordance with embodiments of the disclosure;

FIG. 8A is a schematic sectional view of a top of a carrier structure for a movable window, in accordance with embodiments of the disclosure;

FIG. 8B is a schematic sectional view of a bottom of a carrier structure for a movable window, in accordance with embodiments of the disclosure; and

FIG. 9 is a flowchart of an illustrative process for coupling a window assembly to a vehicle structure, in accordance with embodiments of the disclosure.

### DETAILED DESCRIPTION

A vehicle window system is provided that includes systems, components, and/or assemblies that enable a vehicle structure to couple to different types of windows. In one approach, the vehicle window system includes any of a vehicle structure, a carrier structure, or a window. The carrier structure may be used as an intermediate component to couple the window to the vehicle structure. Different carrier structures may be used for fixed windows and for movable windows. Each of the different carrier structures may couple to a common vehicle structure. Such an approach may improve manufacturability, increase a number of common components between vehicle model variants, and reduce a size or footprint of a vehicle assembly line as discussed below.

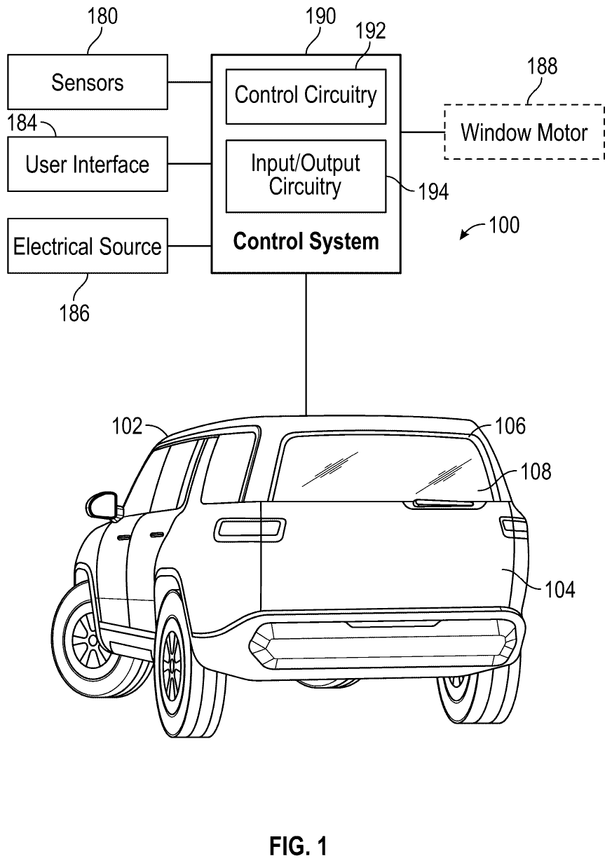

FIG. 1 is a schematic illustration of a vehicle window system 100, in accordance with embodiments of the disclosure. As shown, the system includes a liftgate 104 of a vehicle 102, a window assembly 106, and a control system 190. The window assembly includes a window 108 and is coupled to the liftgate 104. The window assembly may couple at least one of several different types of windows to the same liftgate 104, such as fixed windows and movable windows. In some embodiments, the window assembly is coupled in a vehicle assembly process. Having the liftgate 104 couple to different types of windows may decrease manufacturing costs in the vehicle assembly process that are associated with using a liftgate that is specific to the type of window.

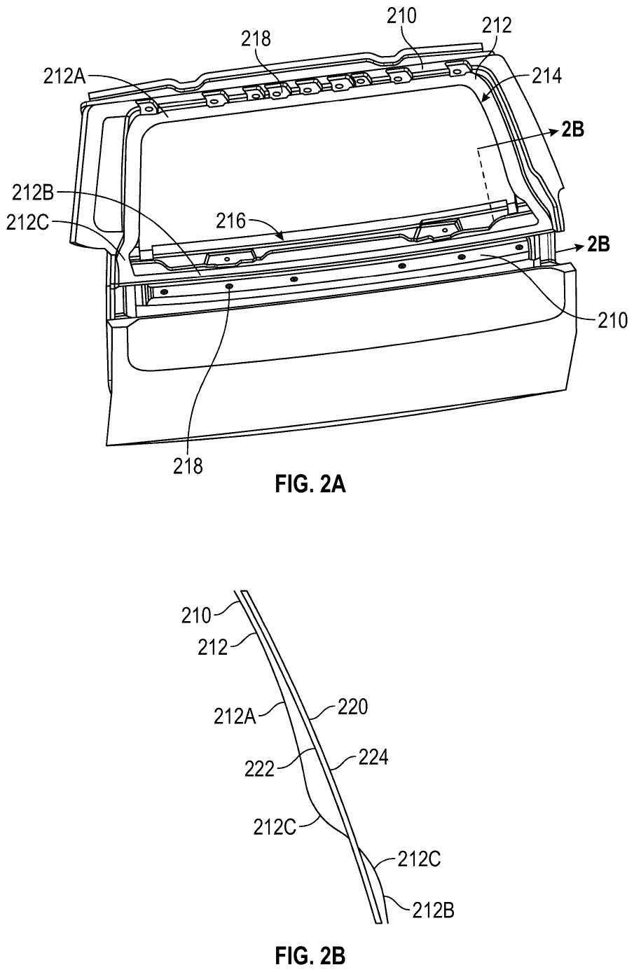

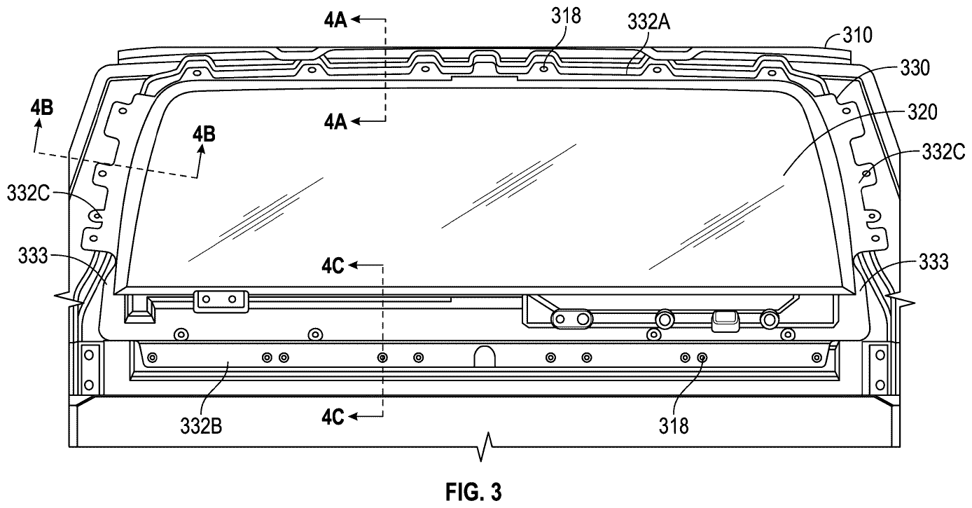

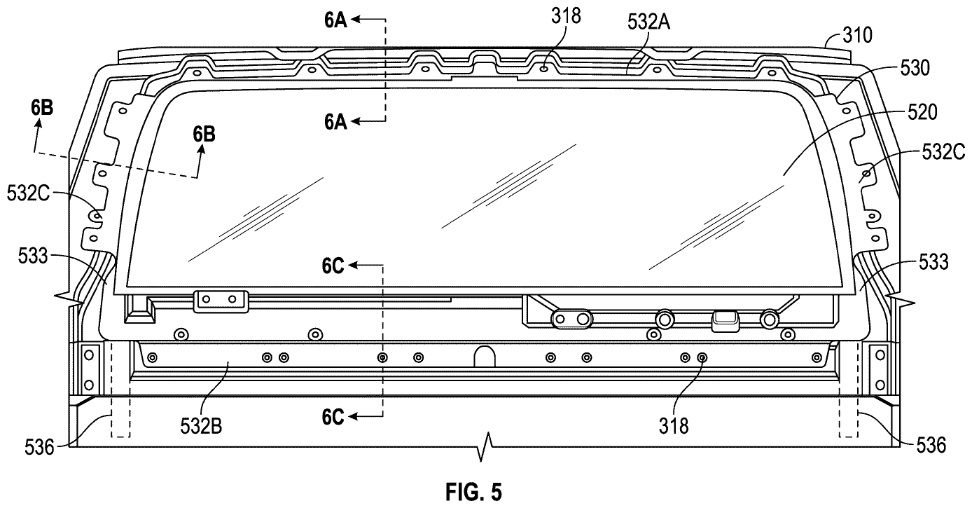

The liftgate 104 includes a vehicle structure (e.g., vehicle structure 210, 310, 710 in FIGS. 2A-8B). The window assembly 106 couples to the vehicle structure. In some embodiments, the window 108 includes a fixed window (e.g., fixed window 320, 720 in FIGS. 3-4C, 7A, or 7B) that does not move in relation to the vehicle structure. In some embodiments, the window 108 includes a movable window (e.g., movable window 520, 820 in FIGS. 5-6C, 8A, or 8B) that moves in relation to the vehicle structure. For example, the movable window moves down to open or lower and up to close or raise.

In some embodiments, the control system includes control circuitry 192 that is coupled to a sensor 180, user interface 184, electrical source 186, window motor 188, and/or any other suitable components to power and/or control the vehicle window system 100. In some embodiments, the control circuitry 192 monitors sensor signals, generates control signals, executes computer readable instructions, receives inputs, or a combination thereof. In some embodiments, the control system includes communications circuitry for communicating with other systems. In some implementations, the communications circuitry includes any of an antenna, receiver, transceiver, transceiver circuitry, or other circuitry, or any combination thereof, and may be configured to access the internet, a local area network, wide area network, Bluetooth-enabled device, near field communication (NFC)-enabled device, Wi-Fi enabled device, cellular (e.g., 2G/3G/4G/5G) enabled device, or any other suitable device using any suitable protocol. In some embodiments, the control system includes input/output (I/O) circuitry 194 (e.g., or I/O path) to receive inputs and/or send outputs. In some implementations, the I/O circuitry receives inputs from and/or sends outputs to the window motor 188, user interface 184, sensors, or communications circuitry. In some embodiments, the control circuitry 192 communicates with the user device through the I/O circuitry. In some embodiments, the I/O circuitry includes, or replaces, the communications circuitry.

In some embodiments, the sensor 180 senses a position of the movable window. In some implementations, the sensor 180 is used to detect if the movable window is closed. In some embodiments, the sensor 180 includes any one or combination of a pressure sensor, transducer, contact sensor, or position sensor, to name a few examples. In some embodiments, the user interface 184 receives inputs to control a movable window of the window assembly 106. In some implementations, the user interface 184 includes any one or combination of switch, lever, button, knob, or display. In one example, a switch may be moved in a first direction to open the movable window and a second direction to close the movable window. In another example, a display may receive an input, e.g., through a touchscreen interface, to move the movable window. In some embodiments, the window motor 188 includes any one or combination of actuators, motors, or any suitable component to move a movable window. In some embodiments, the window motor 188 engages the movable window by one or a combination of a friction fit with a window surface, coupling to an opening or cutout in the window, or any other suitable means.

In some embodiments, the vehicle structure is a supporting structure of the vehicle to which other components are attached. In some implementations, any one or combination of panels, windows, seals, lights, or accessories, to name a few examples, are attached to the vehicle structure.

FIG. 2A is a schematic illustration of a vehicle structure 210 for coupling to different types of windows (e.g., fixed window 320, 720 in FIGS. 3-4C, 7A, or 7B or movable window 520, 820 in FIGS. 5-6C, 8A, or 8B), in accordance with embodiments of the disclosure.

In the embodiment depicted in FIG. 2A, the vehicle structure 210 includes a liftgate structure of a liftgate (e.g., liftgate 104 in FIG. 1). The vehicle structure 210 is located at the rear of a vehicle (e.g., vehicle 102 in FIG. 1). In some implementations, the vehicle structure provides access to a rear interior or trunk of the vehicle. In some embodiments, the vehicle structure 210 is rotatably coupled to a roof structure of the vehicle structure. In some embodiments, the vehicle structure 210 includes a tailgate structure of a tailgate. In some implementations, the tailgate structure comprises a liftgate and a drop gate. In some embodiments, the vehicle structure 210 includes a structure that is not a liftgate structure and/or is not located at the rear of the vehicle. In some implementations, the vehicle structure 210 includes a roof structure of a roof. In some implementations, the vehicle structure 210 includes an automotive pillar or post, such as any one or combination of A pillars, B pillars, C pillars, or D pillars of a vehicle.

In some embodiments, the vehicle structure includes a plurality of surfaces 212 that couple to a window assembly (e.g., window assembly 106 in FIG. 1). In some embodiments, the plurality of surfaces couple to a carrier structure (e.g., carrier structure 330, 530, 730, 830 in FIGS. 3-8B) of the window assembly. In some embodiments, the carrier structure is specific to a type of window. In some embodiments, the plurality of surfaces include a first surface 212A, a second surface 212B, and a transition surface 212C. In some implementations, the transition surface 212C couples to the first surface and the second surface. In some implementations, each of two transition surfaces 212C are coupled to the first surface and the second surface. In some implementations, the transition surface(s) 212C, first surface, and second surface form a continuous surface. In some embodiments, the plurality of surfaces form a sealing surface. In some implementations, a seal is formed between the sealing surface and the window assembly. In some implementations, a seal is positioned between the sealing surface and the window assembly. In some implementations, the seal comprises a gasket that does not adhere to the sealing surface or the window assembly. In some implementations, the seal prevents water from entering the interior of the vehicle. In some embodiments, the vehicle structure includes a plurality of attach points 218 to that couple the vehicle structure to the window assembly. In some implementations, the plurality of surfaces include at least one of the attach points 218. In some implementations, at least one of the attach points 218 is not on the plurality of surfaces.

In some embodiments, the vehicle structure forms an opening 214 for a window (e.g., window 108, 220 in FIG. 1 or 2B). In some implementations, the plurality of surfaces forms the opening 214. In some embodiments, the vehicle structure forms a cavity 216 for receiving at least a portion of the window. In some implementations, a movable window moves through the cavity 216 when lowered or raised.

FIG. 2B is a schematic sectional illustration of the vehicle structure from FIG. 2A and a window 220 (or, e.g., window 108, 320, 520, 720, 820 in FIGS. 1 or 3-8B), in accordance with embodiments of the disclosure. In particular, FIG. 2B shows the plurality of surfaces positioned in relation to the window 220.

The window includes an inner surface 222 and an outer surface 224. In some embodiments, the inner surface faces an inside of the vehicle and the outer surface 224 faces an outside of the vehicle. In some implementations, the inside is an interior of the vehicle, and the outside is the exterior of the vehicle. The transition surface 212C transitions from inward of the inner surface of the window to outward of the outer surface 224 of the window, such as when the carrier structure is coupled to the vehicle structure 210. In some embodiments, the first surface 212A, second surface 212B, and transition surfaces 212C form a continuous surface that transitions from being entirely inward of the inner surface of the window to entirely outward of the outer surface 224 of the window. In some implementations, the continuous surface forms the opening 214. In some embodiments, the window 220 is a fixed window and the first surface 212A is inward of the inner surface 222, the second surface 212B is outward of the outer surface 224, and the transition surface 212C transitions from inward of the inner surface to outward of the outer surface 224. In some embodiments, the window 220 is a movable window that moves between a closed position and an open position. When the movable window is the closed position, the first surface 212A is inward of the inner surface 222, the second surface 212B is outward of the outer surface 224, and the transition surface 212C transitions from inward of the inner surface to outward of the outer surface 224.

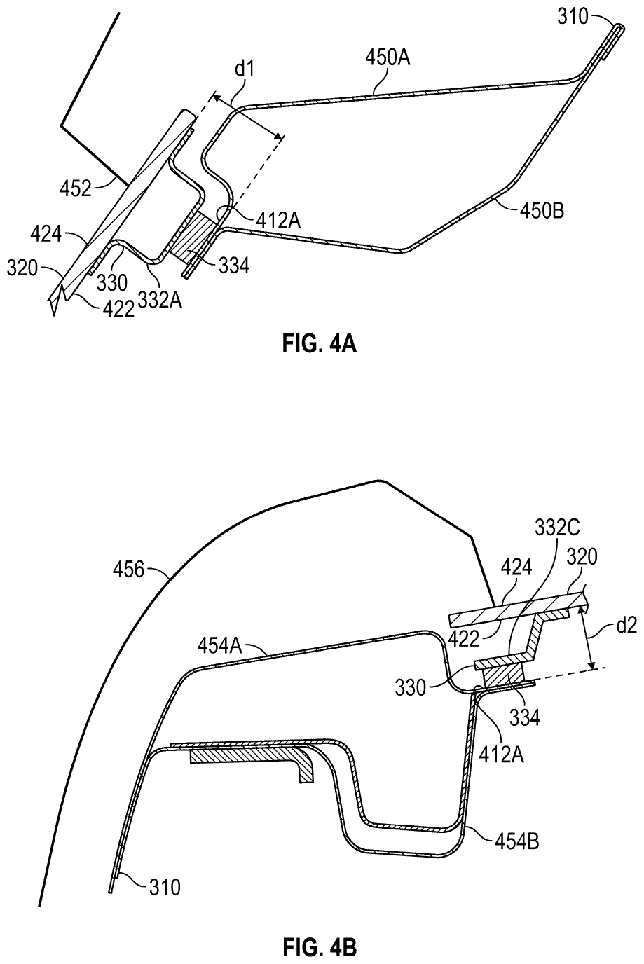

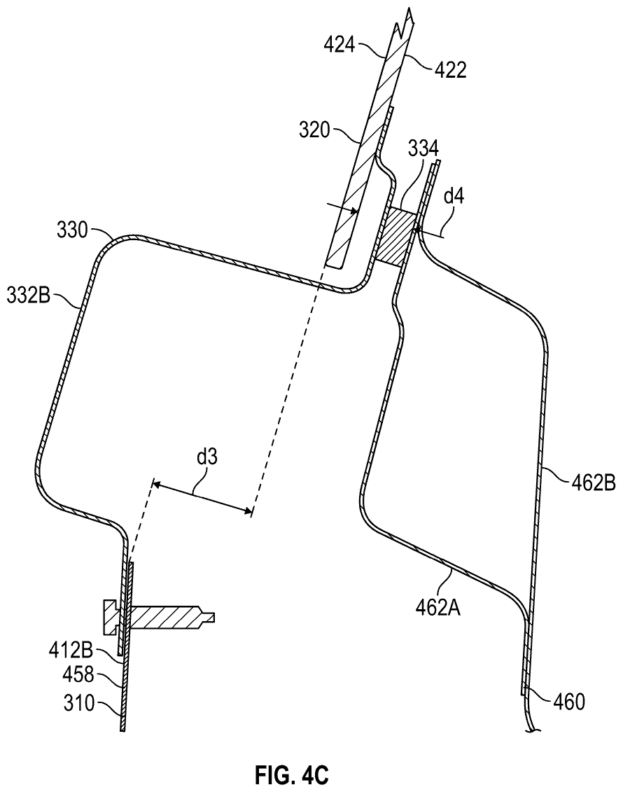

FIGS. 3-4C show different views of a carrier structure 330 for coupling a fixed window 320 to a vehicle structure 310 (e.g., a liftgate structure of a liftgate 104 in FIG. 1). FIGS. 3-4C are herein described together for brevity.

FIG. 3 is a schematic illustration of the carrier structure 330, in accordance with embodiments of the disclosure.

The carrier structure 330 couples to the vehicle structure 310 to secure the fixed window 320 to the vehicle structure 310. The carrier structure 330 includes a top 332A, a bottom 332B, and two sides 332C. The top 332A and two sides 332C of the carrier structure 330 are coupled to a first surface (e.g., first surface 412A in FIGS. 4A and 4B) of the vehicle structure 310. The bottom 332B of the carrier structure 330 is coupled to a second surface (e.g., second surface 412B in FIG. 4C) of the vehicle structure 310. In some embodiments, the carrier structure 330 includes a transition section 333 that is coupled to a transition surface (e.g., transition surface 212C in FIGS. 2A and 2B) of the vehicle structure 310. In some implementations, each of the two sides 332C includes the transition section 333. The transition sections couple the two sides 332C to the bottom 332B. In some embodiments, one of the two sides 332C is a mirrored version of the other side.

In some embodiments, fasteners couple the carrier structure 330 to attach points 318 of the vehicle structure 310. Fasteners may include any of bolts and nuts, screws, anchors, or rivets, to name a few non-limiting examples. In some embodiments, a seal is disposed between any of the top 332A or two sides 332C of the carrier structure 330 and the first surface 412A. In some embodiments, a seal is disposed between the bottom 332B of the carrier structure 330 and the first surface 412A. In some implementations, the seal includes an adhesive or sealant that affixes or bonds the carrier structure 330 to the first surface 412A, second surface 412B, and/or transition surfaces. In some implementations, the seal includes an adhesive strip or bond strip. In some embodiments, the top 332A of the carrier structure 330 is not coupled to a surface of the vehicle structure 310 that is outward of an outer surface (e.g., outer surface 424 in FIGS. 4A-4C) of the fixed window 320, such as to the first surface 412A. In some implementations, the top 332A is coupled to the vehicle structure 310 using the attach points 318.

FIG. 4A is a schematic sectional view of a top 332A of the carrier structure 330 from FIG. 3, in accordance with embodiments of the disclosure.

The top 332A of the carrier structure 330 is coupled to the fixed window 320 and coupled to a first surface 412A of the vehicle structure 310. In some embodiments, the top 332A is coupled to an inner surface 422 of the fixed window 320. The top 332A of the carrier structure 330 positions the fixed window 320 at a first standoff distance (d1) from the first surface 412A. In the embodiment depicted in FIG. 4A, the top 332A forms a U-shape with a flange at each end of the U-shape that couples or attaches to the fixed window 320. The bottom 332B of the U-shape couples to the first surface 412A. In some implementations, a bonding agent 334 affixes or bonds the carrier structure 330 to any of the fixed window 320 or the first surface 412A. In some examples, the bonding agent 334 is selected based on the materials being bonded. In some examples, the bonding agent includes any one or combination of an adhesive, a sealant, a gasket, foam, an adhesive strip, or a bond strip, to name a few examples. In some embodiments, the top 332A forms a shape that differs from a U-shape. In some embodiments, the shape of the top 332A is based on the first standoff distance and/or a shape of the vehicle structure 310. In some embodiments, a fastener couples the top 332A to the vehicle structure 310.

In some embodiments, the vehicle structure 310 includes an interior header outer panel 450A and an interior header inner panel 450B. The interior header panels 450A, 450B may be any of bonded, crimped, fastened, or welded to one another. In some implementations, the first surface 412A is part of the interior header outer panel 450A. In some implementations, the vehicle structure 310 is configured such that first surface 412A is part of the interior header inner panel 450B. In some examples, the interior header inner panel 450B extends further than the interior header outer panel 450A. In some embodiments, the interior header outer panel 450A forms a half-channel that roughly follows half of the U-shape of the top 332A. In some embodiments, the interior header panels 450A, 450B are inward of the inner surface 422 of the fixed window 320.

In some embodiments, an exterior header panel 452 is coupled to the vehicle structure 310. In some embodiments, the exterior header panel 452 is coupled to an outer surface 424 of the fixed window 320. In some embodiments, the exterior header panel 452 is positioned such that a gap is formed between the exterior header panel 452 and the fixed window 320. In some embodiments, the exterior header panel 452 is coupled to the carrier structure 330. In some embodiments, the exterior header panel 452 does not attach to or contact the top 332A.

FIG. 4B is a schematic sectional view of the side 332C of the carrier structure 330 from FIG. 3, in accordance with embodiments of the disclosure.

The side 332C of the carrier structure 330 is coupled to the fixed window 320 and coupled to the first surface 412A. In some embodiments, the side 332C is coupled to a transition surface. In some embodiments, the side 332C is coupled to the second surface. In some embodiments, the side 332C is coupled to an inner surface 422 of the fixed window 320. The side 332C of the carrier structure 330 positions the inner surface 422 of the fixed window 320 at a second standoff distance (d2) from the first surface 412A. In some embodiments, the second standoff distance is substantially similar to the first standoff distance, such as within 5%, 2.5%, or 1% or less. In some embodiments, the second standoff distance is different than the first standoff distance. In some embodiments, the side 332C forms an S-shape. A flange at each end of the S-shape couples to the fixed window 320 and to the first surface 412A, respectively. In some embodiments, an adhesive or sealant attaches the side 332C to any of the fixed window 320 or the first surface 412A. In some embodiments, the side 332C forms a U-shape with flanges at the ends that couple to the fixed window 320 and the bottom 332B of the U-shape couples to the vehicle structure 310. In some embodiments, a fastener couples the side 332C to the vehicle structure 310. In some embodiments, the shape of the side 332C is based on the second standoff distance and/or a shape of the vehicle structure 310.

In some embodiments, the vehicle structure 310 includes an interior side outer panel 454A and an interior side inner panel 454B coupled to one another. In some implementations, the first surface 412A is part of the interior side outer panel 454A. In some embodiments, the interior side outer panel 454A forms a half-channel. In some embodiments, the interior side panels 454A, 454B are at least partially inward of the inner surface 422 of the fixed window 320.

In some embodiments, an exterior side panel 456 is coupled to the vehicle structure 310. In some embodiments, the exterior side panel 456 is coupled to the outer surface 424 of the fixed window 320. In some embodiments, the exterior side panel 456 is positioned such that a gap is formed between the exterior side panel 456 and the fixed window 320. In some embodiments, the exterior side panel 456 is coupled to the carrier structure 330. In some embodiments, the exterior side panel 456 does not attach to or contact the side 332C.

FIG. 4C is a schematic sectional view of the bottom 332B of the carrier structure 330 from FIG. 3, in accordance with embodiments of the disclosure.

The bottom 332B of the carrier structure 330 is coupled to the fixed window 320 and coupled to a second surface 412B of the vehicle structure 310. In some embodiments, the second surface 412B is part of an exterior bottom panel 458. In some implementations, the bottom 332B is attached to the second surface 412B using a fastener. In some embodiments, the bottom 332B is coupled to the inner surface 422 of the fixed window 320. The bottom 332B of the carrier structure 330 positions the outer surface 424 of the fixed window 320 at a third standoff distance (d3) from the second surface 412B. In some embodiments, the third standoff distance is substantially similar to any of the first or second standoff distances. In some embodiments, the third standoff distance is different than at least one of the first or second standoff distances.

In the embodiment depicted in FIG. 4C, the bottom 332B forms an S-shape. A flange at each end of the S-shape couples to the fixed window 320 and to the second surface 412B, respectively. In some embodiments, the end of the S-shape that is closer to the fixed window 320 is coupled to an interior bottom panel 460. In some embodiments, a first side of the bottom 332B is attached to the fixed window 320 and an opposite second side is coupled to the interior bottom panel 460. In some embodiments, an adhesive or sealant affixes or bonds the bottom 332B to any of the fixed window 320, second surface 412B, or the interior bottom panel 460. In some embodiments, the shape of the bottom 332B is based on any one or combination of the third standoff distance, the fourth standoff distance, a shape of the vehicle structure 310, or a shape of the interior bottom panel 460.

In some embodiments, the carrier structure 330 positions the inner surface 422 of the fixed window 320 at a fourth standoff distance (d4) from a surface of the interior bottom panel 460. In some embodiments, the interior bottom panel 460 includes an interior bottom outer panel 462A and an interior bottom inner panel 462B coupled to one another. In some embodiments, any one or combination of the first standoff distance, second standoff distance, or fourth standoff distance are too large for a seal to be formed with an adhesive or sealant to fill the respective standoff distance between vehicle structure and glass. In some implementations, the bottom 332B is coupled to the interior bottom outer panel 462A, such as to a coupling surface of the interior bottom outer panel 462A. In some embodiments, the interior bottom panels 462A, 462B are inward of the inner surface 422 of the fixed window 320. In some embodiments, the vehicle structure 310 includes the interior bottom panel 460.

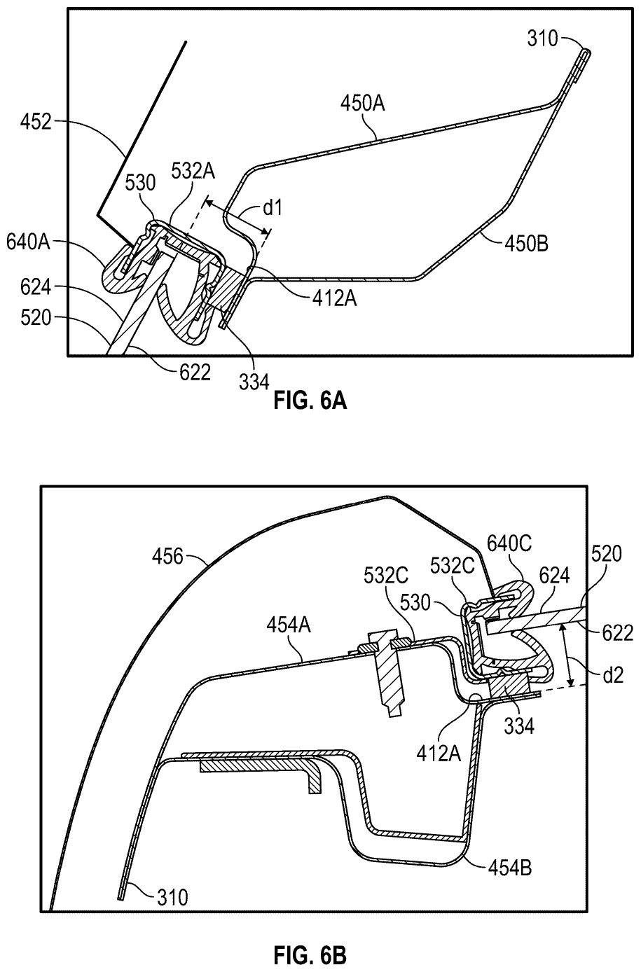

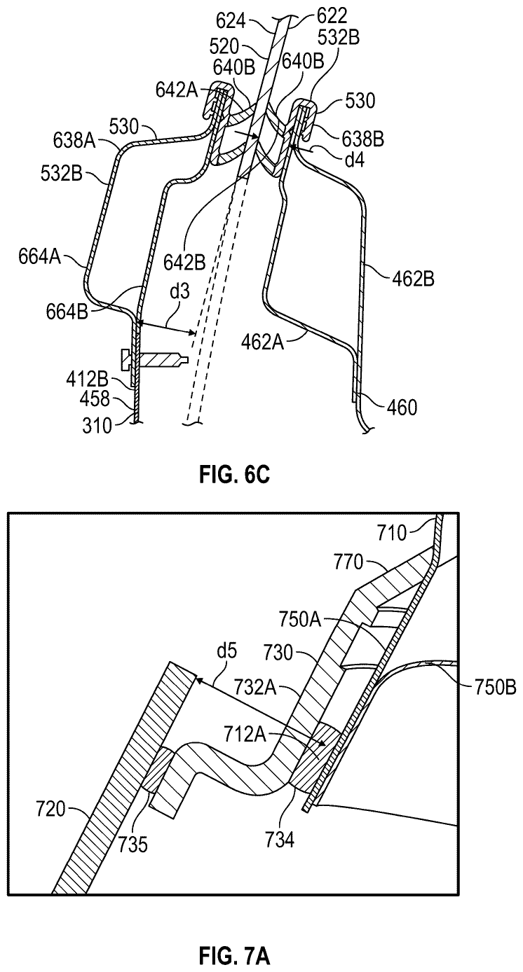

FIGS. 5-6C show different views of a carrier structure 530 for coupling a movable window 520 to the vehicle structure 310. FIGS. 5-6C are herein described together for brevity.

FIG. 5 is a schematic illustration of the carrier structure 530, in accordance with embodiments of the disclosure.

The carrier structure 530 secures the movable window 520 to the vehicle structure 310 by coupling to the vehicle structure 310. A top 532A and two sides 532C of the carrier structure 530 are coupled to the first surface 412A (FIGS. 4A, 4B, 6A, and 6B) of the vehicle structure 310 and a bottom 532B of the carrier structure 530 is coupled to the second surface 412B (FIGS. 4C and 6C) of the vehicle structure 310. In some embodiments, the carrier structure 530 includes a transition section 533 that is coupled to a transition surface (e.g., transition surface 212C in FIG. 2A or 2B) of the vehicle structure 310. In some implementations, each of the two sides 532C includes the transition section 533. In some embodiments, one of the two sides 532C is a mirrored version of the other side.

In some embodiments, the carrier structure 530 is coupled to attach points 318 of the vehicle structure 310 with fasteners. In some embodiments, a seal is disposed between any of the top 332A or two sides 332C of the carrier structure 330 and the first surface 412A and/or the bottom 332B of the carrier structure 330 and the first surface 412A. In some implementations, the seal includes any one or combination of an adhesive, sealant, gasket, foam, adhesive strip, or bond strip, to name a few examples.

In some embodiments, the movable window 520 moves in relation to any of the vehicle structure 310 or the carrier structure 530, such as when the carrier structure 530 is coupled to the vehicle structure 310. In some embodiments, a window motor (e.g., window motor 188 in FIG. 1) moves the movable window 520 between the closed position and the open position. In some embodiments, the carrier structure 530 includes guide rails 536 (e.g., or a track) to guide the movable window 520 when it moves in relation to the carrier structure 530. For example, the guide rails 536 may prevent lateral movement (e.g., left and right) as the movable window 520 moves longitudinally (e.g., up and down). In some examples, the guide rails 536 function as a backstop to prevent the movable window from excess lateral movement. In some examples, each guide rail 536 forms a channel that an edge of the movable window 520 moves through. In the embodiment of FIG. 5, two guide rails 536 are shown attached to or part of the bottom 532B at opposite ends (e.g., left and right) of the bottom 532B. In some embodiments, the guide rails are disposed in a cavity (e.g., cavity 216 in FIG. 2A) of the vehicle structure 310. In some embodiments, the carrier structure 530 does not include the guide rails 536.

FIG. 6A is a schematic sectional view of the top 532A of the carrier structure 530 from FIG. 5, in accordance with embodiments of the disclosure.

The top 532A is coupled to a window seal structure 640A for the movable window 520. In some embodiments, the top 532A forms a U-shape and the window seal structure 640A is coupled to an inner channel of the U-shape. In some implementations, an outer sidewall of the U-shape is coupled to vehicle structure 310. In some examples, an outer sidewall that faces the first surface 412A is coupled to the vehicle structure 310. In some embodiments, the bonding agent 334 attaches the top 532A to the vehicle structure 310. In some embodiments, the top 532A of the carrier structure 530 positions the movable window 520 at the first standoff distance (d1) from the first surface 412A.

The window seal structure 640A contacts the movable window 520 to form a seal when the movable window 520 is in a closed position. In some embodiments, the window seal structure 640A includes teeth or flanges that contact an inner surface 622 of the movable window 520 and/or an outer surface 624 of the movable window 520. In some embodiments, the window seal structure 640A includes tabs that engage indentations in the inner channel of the top 532A to couple the window seal structure 640A to the top 532A. In some embodiments, the window seal structure 640A includes clips that couple the window seal structure 640A to the top 532A by sliding over ends of the inner channel of the top 532A.

FIG. 6B is a schematic sectional view of the side 532C of the carrier structure 530 from FIG. 5, in accordance with embodiments of the disclosure.

The side 532C is coupled to a window seal structure 640C and to one or more of the first surface 412A, second surface 412B, or transition surfaces. The side 532C of the carrier structure 530 positions the movable window 520 at the second standoff distance (d2) from the first surface 412A. In some embodiments, the side 532C forms a U-shape and the window seal structure 640C is coupled to an inner channel of the U-shape. In some embodiments, an outer sidewall of the U-shape is coupled to vehicle structure 310, such as by using the bonding agent 334. In some embodiments, the side 532C includes an S-shaped bracket that is coupled to an outer sidewall of the U-shape at one end and coupled to the vehicle structure 310 at the other end. In some embodiments, a fastener attaches the S-shaped bracket to the interior side outer panel 454A.

The window seal structure 640C contacts the movable window 520 to form a seal when the movable window 520 is in a closed position. When the movable window 520 moves in relation to the carrier structure 530, a portion of the window seal structure 640C that contacts the movable window 520 forms the seal. In some embodiments, the window seal structure 640C includes teeth or flanges that contact the inner or outer surfaces 622, 624 and/or any one or combination of, clips, tabs, or hooks to couple the window seal structure 640B to the side 532C.

FIG. 6C is a schematic sectional view of the bottom 532B of the carrier structure 530 from FIG. 5, in accordance with embodiments of the disclosure.

The bottom 532B of the carrier structure 530 is coupled to a window seal structure 640B and to the second surface 412B of the vehicle structure 310. In some embodiments, the bottom 532B includes a bottom exterior panel 638A and a bottom interior panel 638B. The window seal structure 640B includes a bottom outer seal 642A that couples to the bottom exterior panel 638A and a bottom inner seal 642B that couples to the bottom interior panel 638B. In some implementations, the bottom exterior panel 638A and bottom outer seal 642A and/or the bottom interior panel 638B and bottom inner seal 642B are molded or printed as a single piece, welded or bonded together, or otherwise joined to together to function as a single article. In some embodiments, the window seal structure 640B comprises a different material than the bottom exterior panel 638A and bottom interior panel 638B.

The window seal structure 640B contacts the movable window 520 to form a seal when the movable window 520 is in a closed position. Two dashed lines in FIG. 6C show a path of travel of the movable window 520 as it moves from the closed position to the open position. In some embodiments, at least a portion of the window seal structure 640B contacts the movable window 520 in the open position. In some embodiments, the window seal structure 640B does not contact the movable window 520 in the open position. For example, a top of the movable window 520 may be located between the bottom exterior panel 638A and bottom interior panel 638B and below the window seal structure 640B. In some embodiments, the bottom exterior outer panel 664A and bottom exterior inner panel 664B include teeth or flanges that contact the inner or outer surfaces 622, 624, respectively. The bottom 532B of the carrier structure 530 positions the movable window 520 at the third standoff distance (d3) from the second surface 412B and at the fourth standoff distance (d4) from the surface of the interior bottom panel 460. In some implementations, the bottom exterior panel 638A includes a bottom exterior outer panel 664A and bottom exterior inner panel 664B that are coupled to one another. In some embodiments, any one or combination of the top 532A, bottom 532B, or sides 532C include a run channel coupled to the window seal structure 640A-C, respectively.

In some embodiments, the shape of any one or combination of the top 532A, bottom 532B, or sides 532C is based on the respective second standoff distance (e.g., d1, d2, or d3) and/or a shape of the vehicle structure 310. In some embodiments, the carrier structure 330 is referred to as a fixed mount carrier structure. In some embodiments, the carrier structure 530 is referred to as a run channel carrier structure. In some embodiments, the first surface (e.g., first surface 212A, 412A), second surface (e.g., second surface 212B, 412B), and transition surfaces (e.g., transition surface 212C) form a continuous surface. In some implementations, the bonding agent 334 comprises a carrier seal structure that is between and directly contacting the carrier structure and the continuous surface of the vehicle structure.

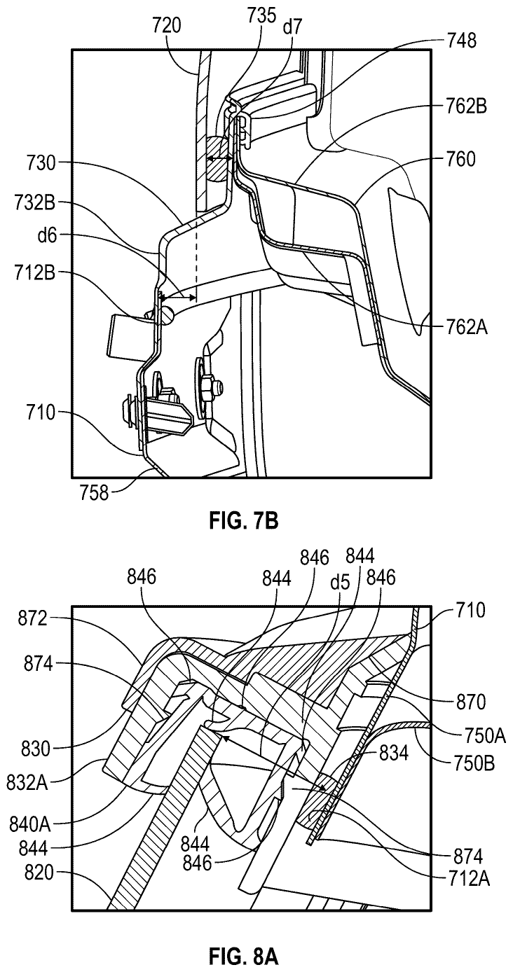

FIGS. 7A and 7B show different views of a carrier structure 730 for coupling a fixed window 720 to a vehicle structure 710 (e.g., a liftgate structure of a liftgate 104 in FIG. 1) and are herein described together for brevity.

FIG. 7A is a schematic sectional view of a top 732A of the carrier structure 730 for the fixed window 720, in accordance with embodiments of the disclosure.

The top 732A is coupled to the fixed window 720, such as with a bonding agent 735. The top 732A is coupled to the vehicle structure 710, which includes interior header outer panel 750A and interior header inner panel 750B. A bonding agent 734 forms a seal between the top 732A and the interior header outer panel 750A, such as between the top 732A and a first surface 712A of the interior header outer panel 750A. In some embodiments, the bonding agent 734 may be the same as the bonding agent 735. In some embodiments, the bonding agent may be different than the bonding agent 735. In some embodiments, fasteners attach the top 732A to the vehicle structure 710. The top 732A positions an inner surface of the fixed window 720 at a fifth standoff distance (d5) from the first surface 712A. In some embodiments, the top 732A includes a transition arm 770 that engages the vehicle structure 710 to position the carrier structure 730. In some implementations, a seal is formed between the transition arm 770 and the vehicle structure 710.

FIG. 7B is a schematic sectional view of a bottom 732B of the carrier structure 730 for the fixed window 720, in accordance with embodiments of the disclosure.

The bottom 732B is coupled to the vehicle structure 710. In some embodiments, fasteners attach the bottom 732B to an exterior bottom panel 758 of the vehicle structure 710. The bottom 732B couples to an interior bottom panel 760, which is formed by an interior bottom outer panel 762A and an interior bottom inner panel 762B. The interior bottom panels 762A, 762B form an upper flange and the bottom 732B includes a hook 748 that engages the upper flange. In some embodiments, the hook 748 includes bumpers that protrude and contact the upper flange. In some implementations, the bumpers engage a notch or tab of the upper flange to prevent decoupling the bottom 732B from the interior bottom panel 760. In some embodiments, the vehicle structure 710 includes the interior bottom panel 760. In some embodiments, the vehicle structure 710 does not include the interior bottom panel 760.

The bottom 732B is coupled to the fixed window 720. In some embodiments, the bonding agent 735 couples the bottom 732B to the inner surface of the fixed window 720. In some embodiments, the bottom 732B includes a section below the fixed window 720 that is angled relative the fixed window 720. In some implementations, the angle between a surface of the section and the window is more than 90 degrees, such as more than 95 degrees, 105 degrees, or 115 degrees. The angle may allow the bottom 732B to direct water falling from the window away from an inside of a vehicle of the vehicle structure 710. The bottom 732B positions an outer surface of the fixed window 720 at a sixth standoff distance (d6) from a second surface 712B of the exterior bottom panel 758. The bottom 732B positions the inner surface of the fixed window 720 at a seventh standoff distance (d7) from the interior bottom outer panel 762A.

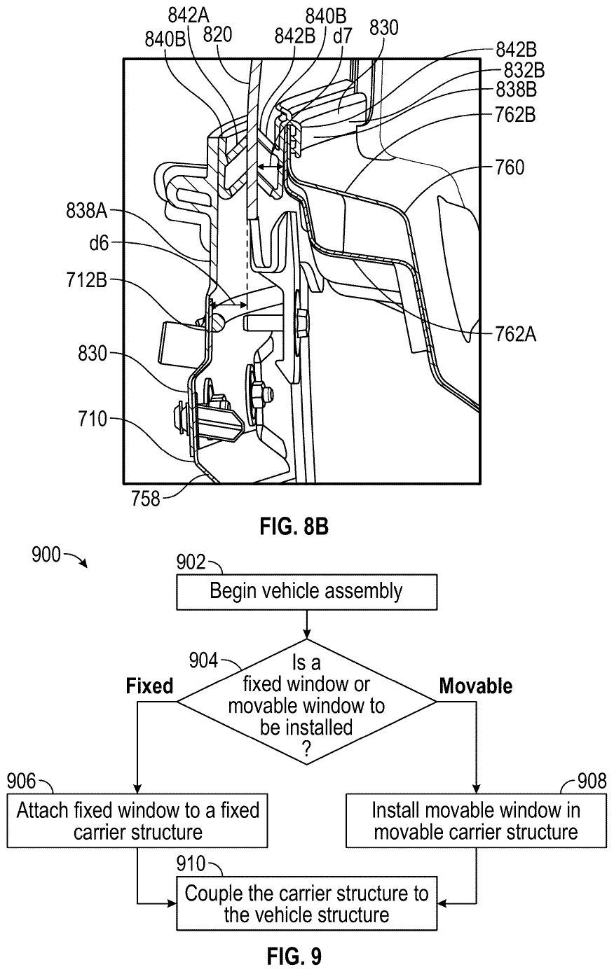

FIGS. 8A and 8B show different views of a carrier structure 830 for coupling a movable window 820 to the vehicle structure 710 and are herein described together for brevity.

FIG. 8A is a schematic sectional view of a top 832A of the carrier structure 830 for the movable window 820, in accordance with embodiments of the disclosure.

The top 832A is coupled to the vehicle structure 710, such as with fasteners and/or a bonding agent 834. The top 832A includes a transition arm 870, carrier run channel 872, and run channel tabs 874. In some embodiments, the carrier run channel 872 includes a U-shape and the run channel tabs 874 are on the inside of the U-shape. The top 832A is coupled to a window seal structure 840A. The window seal structure 840A includes sealing tabs 844 and securing tabs 846. In some embodiments, the securing tabs 846 engage the run channel tabs 874 to secure the window seal structure 840A to the carrier rub channel 872. In some embodiments, the securing tabs 846 engage a notch in the carrier run channel 872. The movable window 820 moves between a closed position and an open position. When the movable window is in the closed position, the sealing tabs 844 engage the movable window 820, such as one or combination of an inner side, outer side, or a top side of the movable window 820. The top 832A and the window seal structure 840A position the inner surface of the movable window 820 at the fifth standoff distance (d5) from the interior bottom outer panel 762A.

FIG. 8B is a schematic sectional view of a bottom 832B of the carrier structure 830 for the movable window 820, in accordance with embodiments of the disclosure.

In some embodiments, the bottom 832B includes a bottom exterior panel 838A and a bottom interior panel 838B. The bottom exterior panel 838A is coupled to the exterior bottom panel 758 of the vehicle structure 710, such as with fasteners. The bottom interior panel 838B forms a hook that is coupled to a flange formed by the interior bottom panel 760. A window seal structure 840B is coupled to the bottom 832B. The window seal structure 840B includes a bottom outer seal 842A and bottom inner seal 842B. In some embodiments, the bottom seals 842A, 842B are one or a combination of welded to, bonded to, molded with, printed with, or integrally formed with the bottom panels 762A, 762B, respectively. In some embodiments, the bottom seals 842A, 842B comprise a different material than the bottom panels 762A, 762B.

The bottom 832B and the window seal structure 840B position the outer surface of the movable window 820 at the sixth standoff distance (d6) from the second surface 712B of the exterior bottom panel 758. The bottom 832B and the window seal structure 840B position the inner surface of the movable window 820 at the seventh standoff distance (d7) from the interior bottom outer panel 762A.

In some embodiments, the carrier structures (e.g., carrier structure 330, 530 or carrier structure 730, 830) discussed in relation to FIGS. 3-8B position the fixed window (e.g., fixed window 320, 720) and the movable window (e.g., movable window 520, 820) at a substantially similar standoff distance from the vehicle structure (e.g., vehicle structure 310, 710). In some implementations, at least one of the d1 through d7 distances is substantially similar when the fixed window and the movable window are coupled to the vehicle structure.

FIG. 9 is a flowchart of an illustrative process 900 for coupling a window assembly (e.g., window assembly 106 in FIG. 1) to a vehicle structure (e.g., vehicle structure 210, 310, 710 in FIGS. 2A-8B), in accordance with embodiments of the disclosure.

In some embodiments, at least one of the operations of process 900 is performed by control circuitry (e.g., control circuitry 192 in FIG. 1). In some embodiments, at least one of the operations of process 900 is performed by a person.

The process 900 begins at operation 902 with beginning a vehicle assembly process, such as described in relation to FIG. 1. In some embodiments, the vehicle assembly process is for assembling any of a system, sub-system, or component or a vehicle.

The process 900 continues to operation 904 with determining whether a fixed window (e.g., fixed window 320, 720 in FIGS. 3-4C, 7A, or 7B) or movable window (e.g., movable window 520, 820 in FIGS. 5-6C, 8A, or 8B) is to be installed, such as described in relation to FIG. 1.

If the determination at operation 904 is the fixed window, then the process 900 continues to operation 906 with attaching the fixed window to a fixed carrier structure (e.g., carrier structure 330, 730 in FIGS. 3-4C, 7A, or 7B), such as described in relation to FIGS. 3-4C, 7A, and 7B. In some embodiments, the fixed window is attached using a bonding agent (e.g., bonding agent 735 in FIG. 7A or 7B) that is deposited on the fixed carrier structure and/or the fixed window. In some implementations, the bonding agent is deposited on one of combination of a top (e.g., top 332A, 732A in FIGS. 3, 4A, or 7A), bottom (e.g., bottom 332B, 732B in FIGS. 3, 4C, or 7B), or side (e.g., side 332C in FIG. 3 or 4B) of the fixed carrier structure.

If the determination at operation 904 is the movable window, then the process 900 continues to operation 908 with installing the movable window in a movable carrier structure (e.g., carrier structure 530, 830 in FIGS. 5-6C, 8A, or 8B), such as described in relation to FIGS. 5-6C, 8A, and 8B. In some embodiments, the movable window is inserted into a bottom (e.g., bottom 532B, 832B in FIGS. 5, 6C, or 8B) of the movable carrier structure, such as between bottom panels (e.g., bottom exterior panel 638A, 838A and bottom interior panel 638B, 838B in FIGS, 6C and 8B) of the movable carrier structure. The movable window may be moved along sides (e.g., sides 532C in FIG. 5 or 6B) of the movable carrier structure until it engages a top (e.g., top 532A, 832A in FIGS. 5, 6A, or 8A).

The process 900 continues from either of operations 906 or 908 and concludes at operation 910 with coupling the carrier structure to the vehicle structure, such as described in relation to FIGS. 2A and 3-8B. In some embodiments, the carrier structure is the fixed carrier structure. In some implementations, the fixed carrier structure is coupled to the vehicle structure using fasteners that engage attach points (e.g., attach points 218, 318 in FIGS. 2A, 3, or 5) of the vehicle structure. In some implementations, the fixed carrier structure is coupled to the vehicle structure using a bonding agent (e.g., bonding agent 334, 734, 834 in FIGS. 4A-4C, 6A, 6B, 7A or 8A) that is deposited on the carrier structure and/or the vehicle structure. In some implementations, the bonding agent is deposited on one or a combination of a first surface (e.g., first surface 212A, 412A, 712A in FIGS. 2A, 2B, 4A, 6A, 7A, or 8A), second surface (e.g., second surface 212B, 412B, 712B in FIGS. 2A, 2B, 4C, 6C, 7B, or 8B), or transition surfaces (e.g., transition surface 212C in FIG. 2A or 2B) of the vehicle structure. In some embodiments, the carrier structure is the movable carrier structure. In some implementations, the fixed carrier structure is coupled to the vehicle structure using one or a combination of fasteners or the bonding agent. In some embodiments, a window motor (e.g., window motor 188 in FIG. 1) is coupled to the movable window.

The foregoing is merely illustrative of the principles of this disclosure and various modifications may be made by those skilled in the art without departing from the scope of this disclosure. The above-described embodiments are presented for purposes of illustration and not of limitation. The present disclosure also can take many forms other than those explicitly described herein. Accordingly, it is emphasized that this disclosure is not limited to the explicitly disclosed methods, systems, and apparatuses, but is intended to include variations to and modifications thereof, which are within the spirit of the following claims.

What is claimed is:

1. An apparatus, comprising:
a carrier structure comprising a top, a bottom, and two sides, the carrier structure configured to be coupled to (i) a vehicle structure of a vehicle and (ii) a window seal structure for a window, wherein:
the window comprises an inner surface configured to face an inside of the vehicle and an outer surface configured to face an outside of the vehicle;
the top and two sides of the carrier structure are configured to be coupled to a first surface of the vehicle structure;
the bottom of the carrier structure is configured to be coupled to a second surface of the vehicle structure;
when the carrier structure is coupled to the vehicle structure:
the first surface of the vehicle structure is inward of the inner surface of the window; and
the second surface of the vehicle structure is outward of the outer surface of the window; and
the first surface and the second surface of the vehicle structure form an opening for the window.

2. The apparatus of claim 1, wherein the carrier structure further comprises two transition sections that respectively couple the two sides to the bottom.

3. The apparatus of claim 2, wherein:
the two transition sections of the carrier structure are configured to be coupled to respective transition surfaces of the vehicle structure; and
when the carrier structure is coupled to the vehicle structure, the transition surfaces of the vehicle structure transition from inward of the inner surface of the window to outward of the outer surface of the window.

4. The apparatus of claim 3, wherein the first surface, the transition surfaces, and second surface form a continuous surface.

5. The apparatus of claim 4, wherein:
the continuous surface transitions from being entirely inward of the inner surface of the window to entirely outward of the outer surface of the window; and
the continuous surface forms the opening for the window.

6. The apparatus of claim 1, wherein the window is configured to be moved in relation to the carrier structure when the carrier structure is coupled to the vehicle structure.

7. The apparatus of claim 1, wherein the top of the carrier structure is not coupled to a surface of the vehicle structure that is outward of the outer surface of the window.

8. The apparatus of claim 1, wherein the window seal structure is configured to directly contact the window.

9. An apparatus, comprising:
a vehicle structure of a vehicle, the vehicle structure comprising a first surface and a second surface configured to be coupled to either one of a first type of carrier structure or a second type of carrier structure, wherein:
the first type of carrier structure is for securing a fixed window to the vehicle structure, the fixed window comprising an inner surface and an outer surface, wherein when the first type of carrier structure is coupled to the vehicle structure:
the inner surface of the fixed window is configured to face an inside of the vehicle and the outer surface of the fixed window is configured to face an outside of the vehicle;
the first surface of the vehicle structure is inward of the inner surface of the fixed window;
the second surface of the vehicle structure is outward of the outer surface of the fixed window; and
the fixed window is configured to be fixed in relation to the vehicle structure; and
the second type of carrier structure is for securing a movable window to the vehicle structure, the movable window comprising an inner surface and an outer surface, wherein when the second type of carrier structure is coupled to the vehicle structure:
the inner surface of the movable window is configured to face an inside of the vehicle and the outer surface of the movable window is configured to face an outside of the vehicle;
the first surface of the vehicle structure is inward of the inner surface of the movable window;
the second surface of the vehicle structure is outward of the outer surface of the movable window; and
the movable window is configured to be moved in relation to the vehicle structure.

10. The apparatus of claim 9, wherein the first type of carrier structure and the second type of carrier structure are configured to position the respective fixed window and movable window at a substantially similar first standoff distance from the first surface.

11. The apparatus of claim 10, wherein the first type of carrier structure and the second type of carrier structure are configured to position the respective fixed window and movable window at a substantially similar second standoff distance from the second surface.

12. The apparatus of claim 9, wherein:
when the first type of carrier structure is coupled to the vehicle structure, the first surface is configured to be coupled to a top and two sides of the first type of carrier structure and the second surface is configured to be coupled to a bottom of the first type of carrier structure; and
when the second type of carrier structure is coupled to the vehicle structure, the first surface is configured to be coupled to a top and two sides of the second type of carrier structure and the second surface is configured to be coupled to a bottom of the second type of carrier structure.

13. The apparatus of claim 12, wherein the first and second types of carrier structures each comprise two transition sections that respectively couple the two sides to the bottom.

14. The apparatus of claim 13, wherein:
the two transition sections of either one of the first type of carrier structure or the second type of carrier structure are configured to be coupled to respective transition surfaces of the vehicle structure;
when the first type of carrier structure is coupled to the vehicle structure, the transition surfaces of the vehicle structure transition from inward of the inner surface of the fixed window to outward of the outer surface of the fixed window; and
when the second type of carrier structure is coupled to the vehicle structure, the transition surfaces of the vehicle structure transition from inward of the inner surface of the movable window to outward of the outer surface of the movable window.

15. A vehicle, comprising:
a vehicle structure comprising a continuous surface that includes a first surface and a second surface;
a window comprising an inner surface and an outer surface; and
a carrier structure coupled to the window and the vehicle structure, the carrier structure comprising a top and a bottom, wherein:
the inner surface of the window faces an inside of the vehicle and the outer surface of the window faces an outside of the vehicle;
the first surface of the vehicle structure is inward of the inner surface of the window and the top of the carrier structure is coupled to the first surface of the vehicle structure; and
the second surface of the vehicle structure is outward of the outer surface of the window and the bottom of the carrier structure is coupled to the second surface of the vehicle structure.

16. The vehicle of claim 15, wherein the carrier structure further comprises two sides each coupled to the top and two transition sections that respectively couple the two sides to the bottom.

17. The vehicle of claim 16, wherein:
the two transition sections of the carrier structure are coupled to respective transition surfaces of the vehicle structure; and
the transition surfaces of the vehicle structure transition from inward of the inner surface of the window to outward of the outer surface of the window.

18. The vehicle of claim 15, wherein the window is configured to be moved in relation to the carrier structure.

19. The vehicle of claim 15, further comprising a carrier seal structure between and directly contacting the carrier structure and the continuous surface of the vehicle structure.

20. The vehicle of claim 19, further comprising a window seal structure between and directly contacting the carrier structure and the window.
